(19) United States
(12) Patent Application Publication
(10) Pub. No.: US 2005/0084583 A1
(43) Pub. Date: Apr. 21, 2005

(54) Pancake bottle

(76) Inventor: Pascal Genini, Auvers Sur Oise (FR)

Correspondence Address: MR. GENINI PASCAL, 41 RUE DU MAROLET, AUVERS SUR OISE, 95430, FR

(21) Appl. No.: 10/687,088

(22) Filed: Oct. 17, 2003

(51) Int. Cl. A21D 10/00

(52) U.S. Cl. 426/549

(57) ABSTRACT

To measure the necessary ingredients to make a pancake pastry, to mix them, to store the resulting pancake pastry into a refrigerator door and to pour out the pancake pastry precisely into a frying pan using two different openings, all this quickly, easily and cleanly using only one kitchen utensil (the invention).

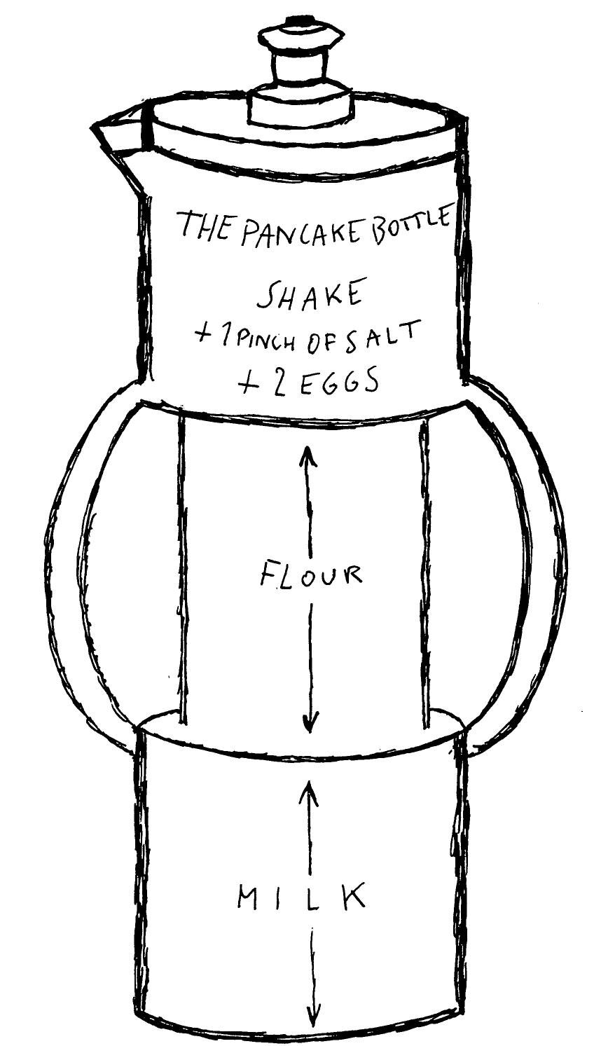

### BACKGROUND OF THE INVENTION

The pancake bottle is a kitchen utensil that is useful to make pancake pastry, to store it in a refrigerator door and to pour it out precisely into a frying-pan. All this using only one pancake bottle, easily, quickly and cleanly and without having to know the necessary ingredients and their quantity needed.

### BRIEF SUMMARY OF THE INVENTION

The pancake bottle is a plastic bottle that is studied to make pancake pastry very quickly and cleanly without using any other kitchen utensil than the pancake bottle itself The user has not to know what are the necessary ingredients and their quantity because these information are written on the pancake bottle. The pancake bottle is able to measure and to contain the necessary ingredients to make a pancake pastry, to mix them by shaking the pancake bottle and to store the resulting pancake pastry in a refrigerator putting the pancake bottle in its door. The pancake bottle has also two openings to pour out the pancake pastry precisely into a frying-pan.

### BRIEF DESCRIPTION OF THE VIEW OF THE DRAWING

The drawing represents the pancake bottle. We can see the characteristics of the invention the indications related to the measurements of the necessary ingredients to make a pancake pastry (arrows and inscriptions “MILK” “FLOUR” “+2 EGGS” “+1 PINCH OF SALT” “SHAKE” “THE PANCAKE BOTTLE”) the two handles, the small cap situated on the large twisting cap that is twisted on the bottle on the drawing, the spout, the narrower part at the level of the handles.

### DETAILED DESCRIPTION OF THE INVENTION

The pancake bottle is a cylindrical plastic bottle that is flexible translucent and light brown coloured.

This bottle has got two handles and is narrower at the level of the handles to be easier to take and to ameliorate the mixing of the ingredients of the pancake pastry.

Its dimensions are:
Diameter: 3.15 inches above and below the central handle, 2.25 inches at the handle level.
Height: 9.84 inches.

The handles begin at 3.15 inches from the bottom of the bottle and end at 6.70 inches from the bottom of the bottle.

There is a spout at the top of the bottle.

The bottle is hermetically closed at its top by a large twisting cap as large as the bottle. When this large cap is twisted, the spout isn't able to let the pancake pastry inside the bottle flowing out.

There is a small sliding cap on the large twisting cap. The small sliding cap is closed when it is down, it is opened when it is up. When it is opened, the small sliding cap let the pancake pastry inside the bottle flowing out if the bottle is tilted and, or squeezed.

1.57 inches from the bottom of the bottle is written the word “MILK”.

Above and below the word “MILK” are drawn two vertical arrows. The one above is directed up. The one below is directed down. These two arrows designate the zone delimited by the bottom of the bottle and the contact points of the handles with the bottle that are situated at 3.15 inches from the bottom of the bottle.

4.92 inches from the bottom of the bottle is written the word “FLOUR”.

Above and below the word “FLOUR” are drawn two vertical arrows. The one above is directed up. The one below is directed down. These two arrows designate the zone situated between the handles. This zone is situated between 3.15 inches from the bottom of the bottle and 6.70 inches from the bottom of the bottle.

The indication “+2EGGS” is written 7 inches from the bottom of the bottle.

The indication “+1PINCH OF SALT” is written 7.74 inches from the bottom of the bottle.

The indication “SHAKE” is written 8.37 inches from the bottom of the bottle.

The indication “THE PANCAKE BOTTLE” is written 9.04 inches from the bottom of the bottle.

Proceeding:

The user of the pancake bottle twists off the large twisting cap. The user adds milk into the pancake bottle until the end of the second arrow. Then the user adds flour until the end of the fourth arrow. And the user adds two eggs and a pinch of salt. (The large opening of the bottle when the large cap is twisted off makes easy the adding of the ingredients.)

The user closes the pancake bottle twisting on the large cap (and being aware that the small sliding cap is closed in a down position).

The user shakes the pancake bottle during approximately 30 seconds. (The handles make the bottle easy to keep in hands.)

It is recommended to let the obtained pancake pastry in a refrigerator during one hour. (The geometry of the pancake bottle makes it easy to be stored in a refrigerator door.)

The user taking back the pancake bottle from the refrigerator shakes it again during approximately 30 seconds to obtain a homogeneous pancake pastry.

The user has two solutions to flow out the pancake pastry from the pancake bottle:
Whether the user prefers a light flow, the user opens the small sliding cap putting it in an up position and the user flows out the pancake pastry turning over the pancake bottle and squeezing it.
Whether the user prefers a large flow, the user opens the large twisting cap and uses the spout tilting the pancake bottle.

1. To make a pancake pastry without having to know the necessary ingredients and their quantity, easily quickly and cleanly using only one kitchen utensil (the invention).

2. To store a pancake pastry into a refrigerator door.

3. To pour out a pancake pastry precisely into a frying-pan using two different openings.
